(19) United States
(12) Patent Application Publication
(10) Pub. No.: US 2006/0241813 A1
(43) Pub. Date: Oct. 26, 2006

(54) Optimized cluster tool transfer process and collision avoidance design

(75) Inventors: Venkatesh Babu, San Jose, CA (US); Russell Kaplan, Sunnyvale, CA (US); Tetsuya Ishikawa, Saratoga, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/338,323

(22) Filed: Jan. 23, 2006

Related U.S. Application Data
(63) Continuation-in-part of application No. 11/112,281, filed on Apr. 22, 2005.

(51) Int. Cl. G05B 19/04

(52) U.S. Cl. 700/255; 700/248

(57) ABSTRACT

The present invention relates to apparatus and method of collision avoidance in a cluster tool having a plurality of processing stations and at least two robots. In one embodiment of the invention, the system is configured such that each of the processing stations is accessible by only one of the at least two robots. For each of the at least two robots, a set of trajectories is determined so that each robot is capable of transferring substrates among the corresponding processing stations, wherein the envelope formed by the set of trajectories of each robot does not overlap.

### CROSS-REFERENCE TO RELATED APPLICATIONS

This application is a continuation in part of U.S. patent application Ser. No. 11/112,281, filed on Apr. 22, 2004, entitled “Cluster Tool Architecture for Processing a Substrate”, which is herein incorporated by reference.

### BACKGROUND OF THE INVENTION

1. Field of the Invention

Embodiments of the present invention generally relate to apparatus and method for transferring semiconductor substrates in an integrated processing system.

2. Description of the Related Art

In modern semiconductor processing, multilayered features are fabricated on semiconductor substrates in a cleanroom environment using specific processing recipes having many processing steps. A cluster tool, which integrates a number of process chambers to perform a sequential processing steps without removing substrates from a highly controlled processing environment, is generally used in processing semiconductor substrates. The process chambers may include, for example, substrate preconditioning chambers, cleaning chambers, bake chambers, chill chambers, chemical vapor deposition chambers, physical vapor deposition chambers, etch chambers, electrochemical plating chambers, and the like. The substrates being processed are generally handled and transferred from one chamber to another by at least one robot comprised in the cluster tool.

Typical cluster tools used to deposit (i.e., coat) and develop a photoresist material, commonly known as a track lithography tool, or used to perform semiconductor cleaning processes, commonly described as a wet/clean tool, will include a mainframe that houses at least one substrate transfer robot which transports substrates between a pod/cassette mounting device and multiple processing chambers that are connected to the mainframe. Cluster tools are often used so that substrates can be processed in a repeatable way in a controlled processing environment. A controlled processing environment has many benefits which include minimizing contamination of the substrate surfaces during transfer and during completion of the various substrate processing steps. Processing in a controlled environment thus reduces the number of generated defects and improves device yield.

The effectiveness of a substrate fabrication process is often measured by two related and important factors, which are device yield and the cost of ownership (CoO). These factors are important since they directly affect the cost to produce an electronic device and thus a device manufacturer's competitiveness in the market place. The CoO, while affected by a number of factors, is greatly affected by the system and chamber throughput, or simply the number of substrates per hour processed using a desired processing sequence. A process sequence is generally defined as the sequence of device fabrication steps, or process recipe steps, completed in one or more processing chambers in the cluster tool. A process sequence may generally contain various substrate (or wafer) electronic device fabrication processing steps. In an effort to reduce CoO, electronic device manufacturers often spend a large amount of time trying to optimize the process sequence and chamber processing time to achieve the greatest substrate throughput possible given the cluster tool architecture limitations and the chamber processing times. In some cluster tools, for example track lithography type cluster tools, the chamber processing times tend to be rather short, (e.g., about a minute to complete the process) and the number of processing steps required to complete a typical process sequence is large, a significant portion of the time it takes to complete the processing sequence is taken up in transferring the substrates between the various processing chambers.

The longest process recipe step will generally limit the throughput of the processing sequence. Sometimes the longest step may be taken by transferring the a substrate by a robot, which is generally referred as robot limited. A track lithography process sequences is generally robot limited due to the short processing times and large number of processing steps. Therefore, reducing transferring time is sometimes an efficient way to increase system throughput and reduce CoO.

Transferring time may be decided by several factors, for example the robot trajectory paths in the sequence, and the time spent on collision avoidance. There are generally multiple paths for a robot to move from one point to another point. Some paths require longer time than other paths. However, the path using the shortest time may take too much space causing collision with the cluster tool, other robots or even the robot itself. In the state-of-the-art cluster tool system, a robot generally constantly “senses” its own position and motion, as well as other moving objects in real time to determine a path and avoid collision. The sensing and determining steps take extra time and slow down the robot. Sometimes, the robot has to stand still and wait for its turn to use a space, which further slows down the system.

Therefore, there exists a need in a cluster tool for apparatus and method for improved trajectory paths and collision avoidance.

### SUMMARY OF THE INVENTION

Embodiments of the invention generally provide apparatus and method for improving trajectory paths and collision avoidance.

One embodiment of the present invention provides a method of collision avoidance in a cluster tool having a plurality of processing stations and at least two robots. The method comprises for each of the at least two robots, determining a set of designated processing stations to which the robot has access, wherein each of the plurality of processing stations is accessible by only one of the at least two robots, and for each of the at least two robots, determining a set of trajectories, wherein each robot is capable of transferring substrates among the corresponding set of designated processing stations by following the corresponding set of trajectories, wherein the set of trajectories for each robot forms an envelope, and the envelope of each robot does not overlap.

Another embodiment of the present invention provides a cluster tool for processing a substrate. The cluster tool comprises a first processing rack containing vertical stacks of substrate processing chambers, a second processing rack containing vertical stacks of substrate processing chambers, a first robot disposed between the first and second processing racks, wherein the first robot is adapted to transfer the substrate among the substrate processing chambers by following a first set of predetermined trajectories, a second robot disposed between the first and second processing racks, wherein the second robot is adapted to transfer the substrate among the substrate processing chambers by following a second set of predetermined trajectories, wherein the first and second set of predetermined trajectories are determined such that the first and second robots do not collide by following the corresponding set of predetermined trajectories.

Yet another embodiment of the present invention provides a method for processing a substrate in a cluster tool. The method comprises providing a plurality of processing stations, providing a first robot configured to transfer substrates among a first set of processing stations of the plurality of processing stations, providing a second robot configured to transfer substrates among a second set of processing stations of the plurality of processing stations, wherein the first and second set of processing stations do not overlap, handling the substrate by the first robot following a first set of predetermined trajectories, transferring the substrate from one of the first set of processing station to one of the second set of processing stations, and handling the substrate by the second robot following a second set of predetermined trajectories, wherein the first and second set of predetermined trajectories are determined such that the first and second robots do not collide by following the corresponding set of predetermined trajectories.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a schematic top view of a cluster tool in accordance with one embodiment of the present invention.

FIG. 2 illustrates an exemplary processing sequence in accordance with cluster tools of the present invention.

FIG. 3 illustrates an exemplary substrate path when the processing sequence of FIG. 2 is performed in the cluster tool of FIG. 1.

FIG. 4 illustrates a schematic view of a robot used in one embodiment of the present invention.

FIG. 5 illustrates a schematic view of a robot used in one embodiment of the present invention.

FIG. 6 illustrates an exemplary point graph in accordance with one embodiment of the present invention.

FIG. 7 illustrates a schematic top view of a mockup cell in accordance with one embodiment of the present invention.

FIG. 8 illustrates an exemplary point tree in accordance with one embodiment of the present invention.

FIG. 9 illustrates an exemplary point tree in accordance with one embodiment of the present invention.

FIG. 10 illustrates an exemplary point tree in accordance with one embodiment of the present invention.

### DETAILED DESCRIPTION OF THE PREFERRED EMBODIMENT

Embodiments of the invention generally provide an apparatus and method for processing substrates using a multi-chamber processing system, e.g., a cluster tool which has robots with optimized trajectory paths and collision avoidance.

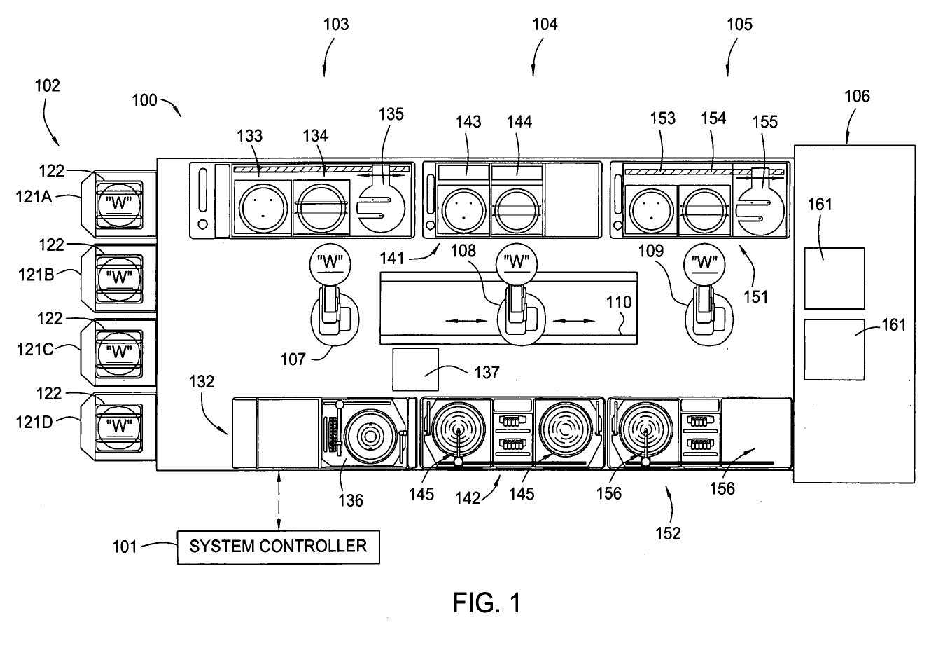

FIG. 1 illustrates a schematic top view of a cluster tool 100 in accordance with one embodiment of the present invention. The cluster tool 100 generally comprises a system controller 101, a factory interface module 102 configured to receive and store substrates from a factory environment, a front module 103 disposed next to the factory interface module 102, a central module 104, a rear module 105 and a stepper module 106. The front, central and rear modules 103, 104 and 105 each comprises two racks of stacked processing chambers disposed on opposite sides.

Generally, a processing rack may contain one or more processing chambers, such as one or more coater chambers, one or more developer chamber, one or more bake/chill chambers. In a processing rack, the processing chambers may be stacked vertically, or one chamber is positioned substantially above another chamber, to reduce footprint of the cluster tool 100 since the clean room space, where the cluster tool 100 may be installed, is often limited and very expensive to build and maintain.

The factory interface module 102 contains one or more front-end opening unified pods (FOUPs) 121A-121D adapted to accept one ore more cassettes 122 that may contain one or more substrates “W” that are to be processed in the cluster tool 100.

The front module 103 comprises a first processing rack 131, a second processing rack 132, and a front robot 107 configured to transfer substrates among the factory interface module 102, the first and second processing racks 131, and 132. In one embodiment, the first processing rack 131 may comprises a plurality of thermal modules vertically stacked together. Each of the thermal modules may comprise a bake station 133 configured to bake a wafer to a specified temperature, a chill station 134 configured to evenly cool the wafer after a baking process, and a shuttle station 135 configured to receive the substrate from a robot, support and transfer the substrate between the bake station 133 and the chill station 134. A detailed description for a thermal module may be found in United Patent Application entitled “Integrated Thermal Unit Having Bake and Chill Plates”, attorney docket number A9999/T60600, which is herein incorporated as a reference. The second processing rack 132 may comprise a plurality of coater chambers 136 which may be adapted to perform, for example, the bottom anti-reflective coating (BARC) step, the photoresist coating step, the anti-reflective top coating step, and the shrink assist film for enhanced resolution (SAFIER™) coating step.

The central module 104 comprises a first processing rack 141, a second processing rack 142 and a central robot 108 movable towards the front module 103 and the rear module 105 along a track 110. The central robot 108 is configured to transfer substrates among the central module 104 and at least part of the front module 103 and rear module 105. In one embodiment, the first processing rack 141 comprises a plurality of vertically stacked bake stations 143 and a plurality of vertically stacked chill stations 144. The second processing rack 142 may comprise a plurality of coater/developer chambers 145 which may be adapted to perform a photoresist coating step. In one embodiment, the coater/developer chamber 145 may be also configured to perform optical edge bead removal (OBER) process after a coating step.

In one embodiment, a plurality of depair stations 137 is generally disposed between the front module 103 and the central module 104 in front of the processing racks 132 and 142. The depair stations 137 may be adapted to be accessible from at least two directions. Therefore, two robots, such as the front robot 107 and the central robot 108 may access the depair station 137 from different directions simultaneously without collision. In another aspect, the depair stations 137 may also de-pair the substrates being processed. Via the depair stations 137, a robot that handles two substrates at a time may pass the substrates to a robot that handles only one substrate at a time.

The rear module 105 comprises a first processing rack 151, a second processing rack 152 and a rear robot 109. The rear robot 109 is configured to transfer substrates among the first processing rack 151, the second processing rack 152 and the stepper module 106. In one embodiment, the first processing rack 151 may comprise, a plurality of bake stations 153, and a plurality of chill stations 154 and a plurality of shuttle stations 155. The second processing rack 152 may comprise a plurality of coater/developer chambers 156, which may be adapted to perform a developing step.

The stepper module 106 may comprise stepper scanners 161 configured to form a pattern on a substrate used to manufacture integrated circuits.

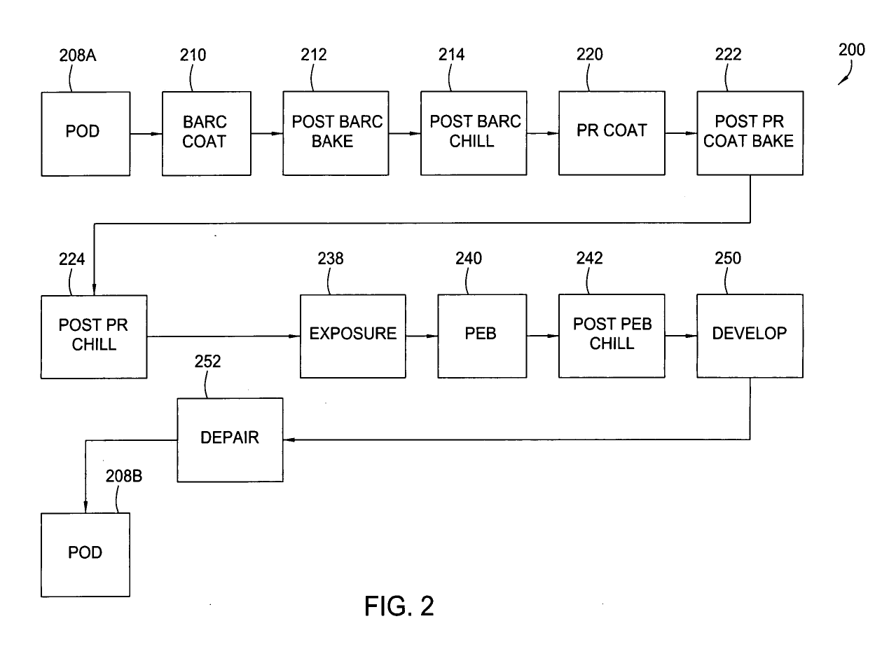

The cluster tool 100 may be adapted to performed a photolithography process, which generally includes deposit, expose and develop a photoresist material layer on a substrate surface. FIG. 2 illustrates an exemplary photolithography sequence 200 which may be performed by the cluster tool 100. The sequence 200 generally contains the following: a remove substrate from pod 208A step, a BARC coat step 210, a post BARC bake step 212, a post BARC chill step 214, a photoresist coat step 220, a post photoresist bake step 222, a post photoresist chill step 224, an exposure step 238, a post exposure bake (PEB) step 240, a post PEB chill step 242, a develop step 250, a depair step 252, and return in pod step 208B. It should be noted that the sequence 200 may be rearranged, altered, one or more steps may be removed, or two or more steps may be combined into a single step.

The remove substrate from pod 508A step is generally defined as the process of removing a substrate from a cassette, for example the cassette 122 in one of the FOUPs 121A-D of the cluster tool 100.

The BARC coat step 210 is a step used to deposit an organic material over a surface of the substrate. The BARC layer is typically an organic coating that is applied onto the substrate prior to the photoresist layer to absorb light that otherwise would be reflected from the surface of the surface back into the photresist during the exposure step 238 performed in a stepper/scanner. The BARC coat step 210 is typically performed using a conventional spin-on photoresist dispense process in which an amount of the BARC material is deposited on the surface of the substrate while the substrate is being rotated, which causes a solvent in the BARC material to evaporate and thus causes the material properties of the deposited BARC material to change.

The post BARC bake step 212 is a step used to assure that all of the solvent is removed from the deposited BARC layer in the BARC coat step 210, and in some cases to promote adhesion of the BARC layer to the surface of the substrate. The temperature of the post BARC bake step 212 is dependent on the type of the BARC material deposited on the surface of the substrate, but will generally be less than about 250° C. The time required to complete the post BARC bake step 212 will depend on the temperature of the substrate during the post BARC bake step, but will generally be less than about 60 seconds.

The post BARC chill step 214 generally cools the substrate after the post BARC step 212 to a temperature at or near ambient temperature to assure that the substrate is at a temperature above ambient temperature is controlled so that every substrate sees the same time-temperature profile; thus process variability is minimized. The time required to complete the post BARC chill step 214 will depend on the temperature of the substrate exiting the post BARC bake step, but will generally be less than about 30 seconds.

The photoresist coat step 220 is a step used to deposit a photresist layer over a surface of the substrate. The photoresist layer deposited during the photoresist coat step 220 is typically a light sensitive organic coating that is applied onto the substrate and is later exposed in a stepper/scanner to form the patterned features on the surface of the substrate. The photoresist coat step 220 is typically performed using conventional spin-on spin-on photoresist dispense process in which an amount of the photresist material is deposited on the surface of the substrate while the substrate is being rotated, thus causing a solvent in the photoresist material to evaporate and the material properties of the deposited photoresist layer to change. In one embodiment, an optical edge bead removal (OBER) step may be performed after the photoresist coat step 220 to expose the deposited light sensitive photoresist layers, such as the layers formed during the photoresist coat step 220 and the BARC layer formed during the BARC coat step 210, to a radiation source so that either or both layers can be removed from the edge of the substrate and the edge exclusion of the deposited layers can be more uniformly controlled.

The post photoresist bake step 222 is used to assure that most, if not all, of the solvent is removed from the deposited photoresist layer in the photoresist coat step 220, and in some cases to promote adhesion of the photresist layer to the BARC layer. The temperature of the post photoresist bake step 222 is dependent on the type of the photoresist material deposited on the surface of the substrate, but will generally be less than about 250° C. The time required to complete the post photoresist bake step 222 will depend on the temperature of the substrate during the post photoresist bake step, but will generally be less than about 60 seconds.

The post photoresist chill step 224 generally cools the substrate after the post photoresist bake step 222 to a temperature at or near ambient temperature to assure that the substrate is at a temperature above ambient temperature is controlled so that every substrate sees the same time-temperature profile; thus process variability is minimized. The time required to complete the post photoresist chill step 224 will depend on the temperature of the substrate exiting the post photoresist bake step, but will generally be less than about 30 seconds.

The exposure step 238 is a lithographic projection step applied by a lithographic projection apparatus, e.g., the stepper scanner 161 of the cluster tool 100, to form a pattern which is used to manufacture integrated circuits (ICs). The exposure step 238 forms a circuit pattern corresponding to an individual layer of the IC device on the substrate surface, by exposing the photoresist coat step 220 and the BARC layer formed during the BARC coat step 210 of some form of electromagnetic radiation.

The post exposure bake (PEB) step 240 is a step used to heat a substrate immediately after the exposure step 238 to stimulate diffusion of the photoactive compounds and reduce the effects of standing waves in the photoresist layer. For a chemically amplified photoresist, the PEB step also causes a catalyzed chemical reaction that changes the solubility of the photoresist. The control of temperature during the PEB step 240 is critical to critical dimension (CD) control. The temperature of the PEB is dependent on the type of the photoresist material deposited on the surface of the substrate, but will generally be less than about 250° C. The time required to complete the post photoresist bake step 222 will depend on the temperature of the substrate during the post photoresist bake step, but will generally be less than about 60 seconds.

The post PEB chill step 242 generally cools the substrate after the PEB step 240 to a temperature at or near ambient temperature to assure that the substrate is at a temperature above ambient temperature is controlled so that every substrate sees the same time-temperature profile; thus process variability is minimized. The time required to complete the post PEB chill step 242 will depend on the temperature of the substrate exiting the post photoresist bake step, but will generally be less than about 30 seconds.

The develop step 250 is a process in which a solvent is used to cause a chemical or physical change to the exposed or unexposed photoresist and BARC layers to expose the pattern formed during the exposure step 238. The develop process may be a spray or immersion or puddle type process that is used to dispense the developer solvent. In some cases, after the solvent has been dispensed on the surface of the substrate, a rinse step may be performed to rinse the solvent material from the surface of the substrate.

After the develop step 250, the substrate is returned to a pod in step 208B to conclude the photolithography sequence 200. In one embodiment, the returning may include a depair step 252 in which the substrate is dropped off to a depair station, such as the depair station 137 in FIG. 1, by one robot and picked from the depair station by another robot which returns the substrate to the pod.

The photolithography sequence 200 is a typical process which may be modified by adding or removing processing steps according to particular requirements. Some steps, for example the post BARC bake step 212, may be performed in several locations of in a cluster tool, for example, the bake station 133 of the front module 103, the bake station 143 of the central module 104, or the bake station 153 of the rear module 105. And some chambers, for example the bake station 133, may be configured to perform several process steps, such as the post BARC bake step 212, the post photoresist bake step 222, and the PEB step 240. Therefore, a substrate to be photolithography processed in a cluster tool may take flexible and variable paths. A path with less substrate handoffs, avoidance of robot collision and increased throughput is usually desirable.

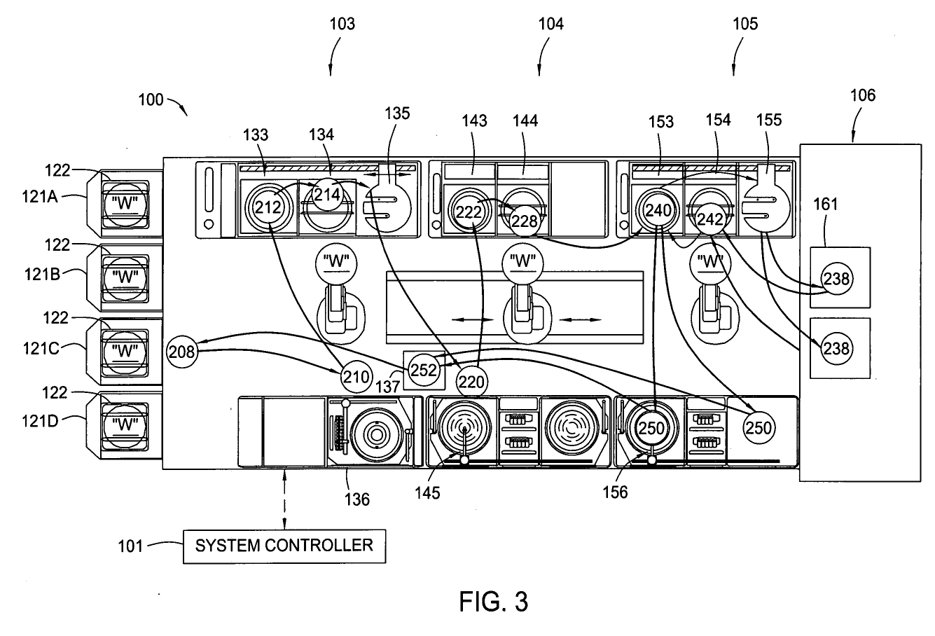

FIG. 3 is a plan view of the cluster tool shown in FIG. 1 that illustrates an exemplary transfer path of a substrate following the process sequence illustrated in FIG. 2.

A substrate generally starts from a cassette 122 in one of the pods 121A-D. The substrate may then be moved from the cassette 122 to the coater chamber 136 where the BARC coat step 210 may be performed. Upon finishing the BARC coat step 210, the substrate may be transferred to the bake station 133 where the post BARC bake step 212 may be performed. After the post BARC bake step 212, the substrate is transferred to the chill station 134 where the post BARC chill step 214 is performed. In one embodiment, the transferring between the bake station 133 and the chill station 134 may be conducted by a robot or the shuttle station 135 and after the post BARC chill step 214, the substrate may be transferred from the shuttle station 135 to the coater/developer chamber 145 where the photoresist coat step 220 may be performed. The substrate is then transferred to the bake station 143 where the post photoresist bake step 222 may be performed. After the post photoresist bake step 222, the substrate is transferred to the chill station 144 where the post photoresist chill step 224 may be performed. The substrate is then transferred to the stepper scanner 161 where the exposure step 238 is performed. After the exposure step 238, the substrate is transferred to the bake station 153 where the PEB step 240 is performed. Next, the substrate is transferred to the chill station 154 where the PEB chill step 242 is performed. The substrate is then transferred to the coater/developer chamber 156 where the develop step 250 is performed. The substrate is now ready to return to the pod. In one embodiment, the returning path may include transferring the substrate from the coater/developer chamber 156 to the depair station 137 and from the depair station 137 to the cassette 122.

The transferring of substrate in FIG. 3 is generally conducted by the front, central and rear robots 107, 108 and 109 with the exception that the substrate may be transferred by a shuttle station between a bake station and a chill station.

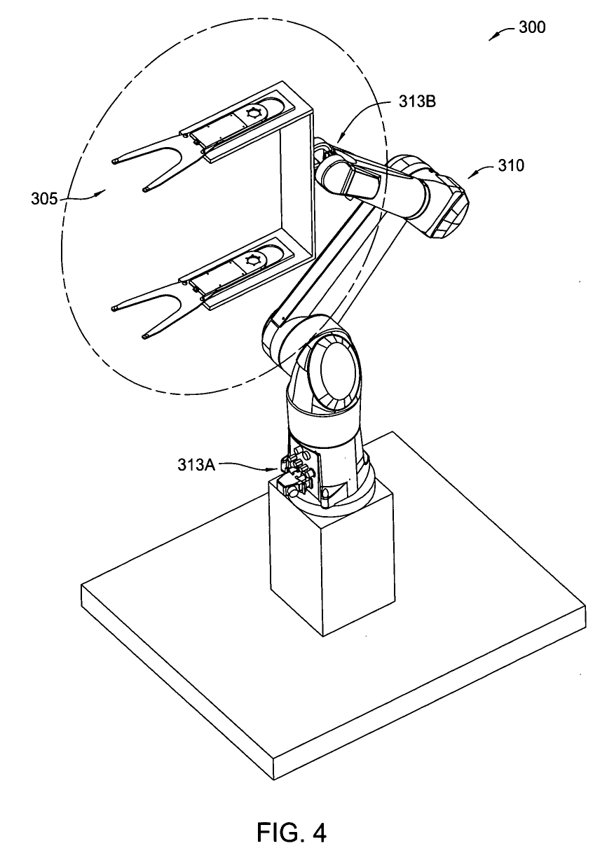

FIG. 4 illustrates an isometric view of an exemplary articulated robot assembly 300 (hereafter AR assembly 300). The AR assembly 300 generally contains articulated robot 310 and a dual blade assembly 305. The articulated robot 310 is generally a 6-axis articulated robot which can be purchased from Mitsubishi Electric Corporation, of Tokyo, Japan, Kawasaki Robotics (USA), Inc. of Wixom, Mich., and Staubli Corp. of Duncan, S.C. In one embodiment, the 6-axis articulated robot is a model number TX90 purchased from Staubli Corp. of Duncan, S.C. The articulated robot 310 has a robot base 313A and a mechanical interface 313B, which connect the robot to the cluster tool and the end-effector assembly (e.g., dual blade assembly 705) to the robot, respectively. In general, the 6-axis articulated robot is advantageous since the reach of the articulated robot is far superior from conventional robots due to its multiple axis and multiple linkage design, the reach of multiple articulated robots can more easily “overlap” since the motion of the end-effector, which retains and transfers the substrate(s), is not linked to motion of the robot base 313A which allows the robots to more effectively avoid each other while transferring substrates, and/or the reliability of the articulated robots exceeds most conventional robots. In one embodiment, the AR assembly 300 may be used as the front and rear robots 107 and 109 of the cluster tool 100. In one embodiment, the AR assembly 300 may have only one blade assembly 305.

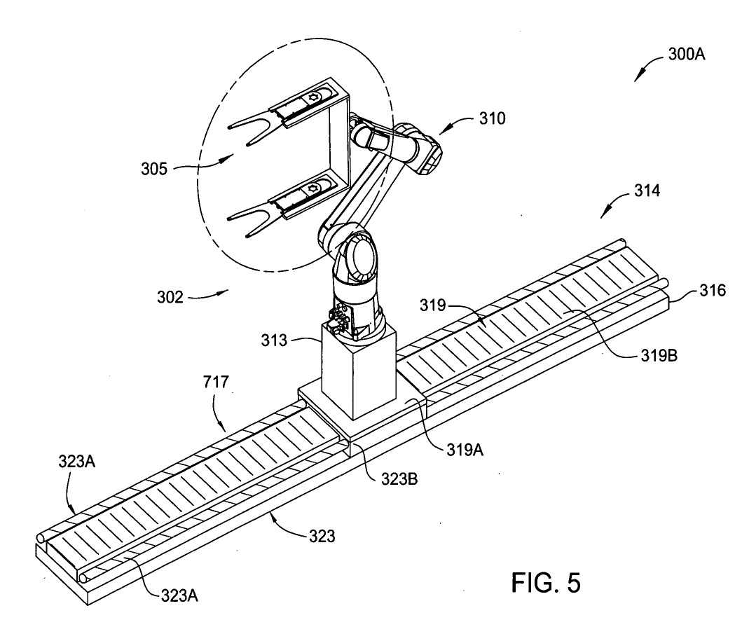

FIG. 5 illustrates an isometric view of one embodiment of a moveable articulated robot assembly 300A wherein the articulated robot base 313 is allowed to be translated and positioned along the length of a cluster tool by use of a slide assembly 314. In this configuration the articulated robot base 313 is connected to an actuator assembly 317 of the slide assembly 314, which is adapted to move the AR assembly 300A to a desired position in the cluster tool by use of commands from a system controller, for example, the system controller 101. The slide assembly 314 generally contains an actuator assembly 317, a cover (not shown), and a base 316. The base 316 supports and mounts the AR assembly 300A and slide assembly components to the cluster tool. The cover, not shown for clarity, is used to enclose the actuator assembly 317 and other slide assembly features to prevent generated particles from making their way to the processing chambers and prevent damage to these features during maintenance of the cluster tool. The actuator assembly 317 may generally contain an actuator 319 and a guiding mechanism 323. In one embodiment, the actuator 319 is a direct drive linear brushless servomotor, which through communication with the base component 319A (e.g., secondary coil or “rotor” section) mounted on the base 316 and a slider 319B (e.g., stator), is adapted to move the AR assembly 300A along the length of the slide assembly 714. A direct drive linear brushless servomotor that may be purchased from Danaher Motion of Wood Dale, Ill. or Aerotech, Inc. of Pittsburgh, Pa. In other embodiments, the actuator 319 may be stepper motor or other type of actuator that can be used to position the robot. The guiding mechanism 323 is mounted to the base 316 and is used to support and guide the robot as it is moved along the length of the slide assembly 314. The guide mechanism 323 may be a linear ball bearing slides or a conventional linear guide, which are well known in the art. In one embodiment, the AR assembly 300A may be used as the central robot 108 of the cluster tool 100.

Robots used in a cluster tool, such as the AR assemblies 300 and 300A, are capable of moves with 6 or even 7 degrees of freedom (DOF) within their envelopes. The robots in a cluster tool are configured to transfer substrate among locations within the cluster tool, for example various chambers, in a predetermined sequence. During operation, a controller, for example the system controller 101 of the cluster tool 100, generally specifies a destination, for example a chamber in the cluster tool, to a robot controller which places a specific motion request onto a motion stack to be executed in turn.

A destination for a robot may be described as either a joint or a point. A joint is a point in joint space that corresponds to actual joint rotational positions of a robot. A point is a point in Cartesian Space and a joint configuration because each position in Cartesian Space may be attainable by up to 8 different joint position combinations. When a point is specified, a frame which is a linear transformation in Cartesian Space and a tool which represents an end-effector must also be specified.

Once the destination is specified in the form of a point or a joint, there are two kinds of motions may be used to move a robot into the destination. The two kinds of motions are joint motion and linear motion. The joint motion performs the fastest possible motion from the current position to either a point or a joint. The actual path is determined by several factors including the different speed capabilities of the motors. The path for a joint motion is almost never the shortest path in Cartesian space as seen by a tool. The linear motion performs a motion from the current position to a point and requires the specified tool of the point remains in a straight line in Cartesian space.

Beside speedy and accurate motion, the system controller needs solutions for collision avoidance as well. In the state-of-the-art system, there are five types of collision avoidance: self collision avoidance, known static collision avoidance, known dynamic collision avoidance, unknown static collision avoidance, and unknown dynamic collision avoidance. Self collision avoidance avoids collisions of the robot arms or tools with themselves. Some robots are capable of preventing self collision of arms at run time, but are not aware of any tools except as a point in space. Known static collision avoidance avoids collision of the robot and tools with static objects within the work cell. The static objects do not move and are usually known ahead of time. Known dynamic collision avoidance avoids collision of the robot and tools with objects that move in the work cell. In this case, all potential positions of objects, including the envelope described by the entire tool as it moves, are known ahead of time. Unknown static collision avoidance avoids collision with non-moving objects that are not know ahead of time. Unknown dynamic collision avoidance avoid collision with moving objections whose path is not known ahead of time. To avoid unknown static or dynamic objects generally requires object detection through the use of sensors and are more difficult than the first three collision avoidance.

In one embodiment, self collision avoidance and static collision avoidance may be achieved by using predefined intermediate points. For example, when moving from A to B using a joint motion, one of the arms of the robot would hit a skin causing a collision. In this case, an intermediate point 1 may be introduced so that the robot moves from A to 1 to B (or B to 1 to A) to avoid the collision. In one embodiment, a point graph of intermediate points may be obtained by using a path-finding graph algorithm. Through the point graph of intermediate points, a set of trajectories between any two given points that allow for safe non-colliding motions may be found. In one aspect, the intermediate points and the point graph may be calculated offline which requires no real-time calculation, hence, improves the robot efficiency.

In another embodiment, self collision avoidance and static avoidance may be achieved by optimizing use of linear vs. joint motions. For the same example, when moving from A to B using a joint motion, one of the arms of the robot would hit a skin causing a collision. A linear motion from A to B may be used to avoid the collision.

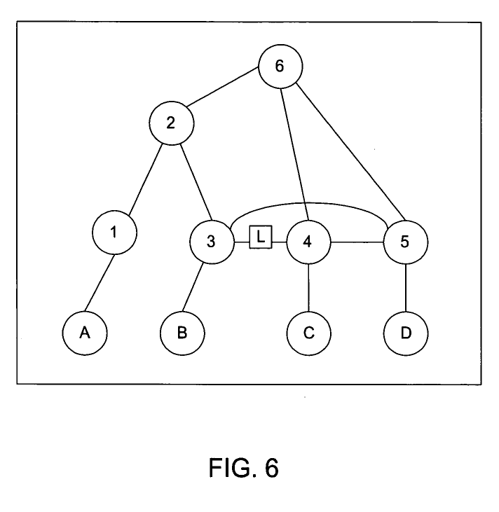

FIG. 6 illustrates an exemplary point graph of intermediate points of the present invention. The bottom row nodes A, B, C and D indicate destination locations, for example, chamber locations in a cluster tool. Nodes 1-6 are intermediate points through which the robot can navigate among nodes A, B, C and D without collision. The robot can not move directly from nodes 1 to 3 without collision, so node 2 is introduced. The motion from nodes 3 to 4 is made linear rather than the faster joint motion to avoid potential collision.

In cluster tools for semiconductor processing, dynamic collision is mainly created by multiple robots since there are no moving objects other than the robot themselves. In one embodiment, dynamic collision avoidance may be treated as a variation of static collision avoidance problem by creating “avoidance envelopes” for the multiple robots. The physical space occupied by a set of motions of a robot when the robot follows a set of trajectories is defined as an envelope of the set of motions of the robot. An envelope of a set of motions as a robot follows a set of known trajectories may be treated as a static obstacle, which may be avoided by optimally choosing sufficient intermediate points when designing trajectories of other robots. The problem of dynamic collision avoidance is of roughly the same complexity of a problem of known static collision avoidance although it may be of an increased magnitude.

During operation, each robot follows the set of trajectory, therefore stays within a corresponding envelope all the time. The envelope of each robot does not overlap with another. There will be no collision between robots no matter when any given motion request is made since the robots follow the fixed trajectories exclusively.

In one embodiment, in a cluster tool having multiple robots, each destination, i.e. station/chamber, is accessible by only one robot by employing shuttle stations and de-pairs in the cluster tool, wherein a de-pair enables a station to be dual accessible from opposite directions, and a shuttle station allows one robot to drop off from one side and another robot to pick up from another side.

In one embodiment, trajectories and avoidance envelopes of two or more robots may be fitted simultaneously using a feedback mechanism. In one embodiment, the trajectories and avoidance envelopes of multiple robots may be found using visual simulation and/or experimentations. It should be noted that the avoidance envelopes are calculated offline once fundamental architecture of a cluster tool is established and no run-time calculation is required, therefore, increasing system throughput.

In one embodiment, measurement and/or adjustment may be taken during controller startup or error recovery to ensure that the robots are at a well-known point at all times. In one embodiment, manual intervention may be used to put a robot at a well-known point during controller startup or error recovery.

In one embodiment, the collision avoidance trajectory of each robot in a cluster tool may be found using a mockup cell created using optimization software. In another embodiment, positions of static elements, such as positions of the robots and/or link lengths, may be optimized in searching of collision avoidance trajectories.

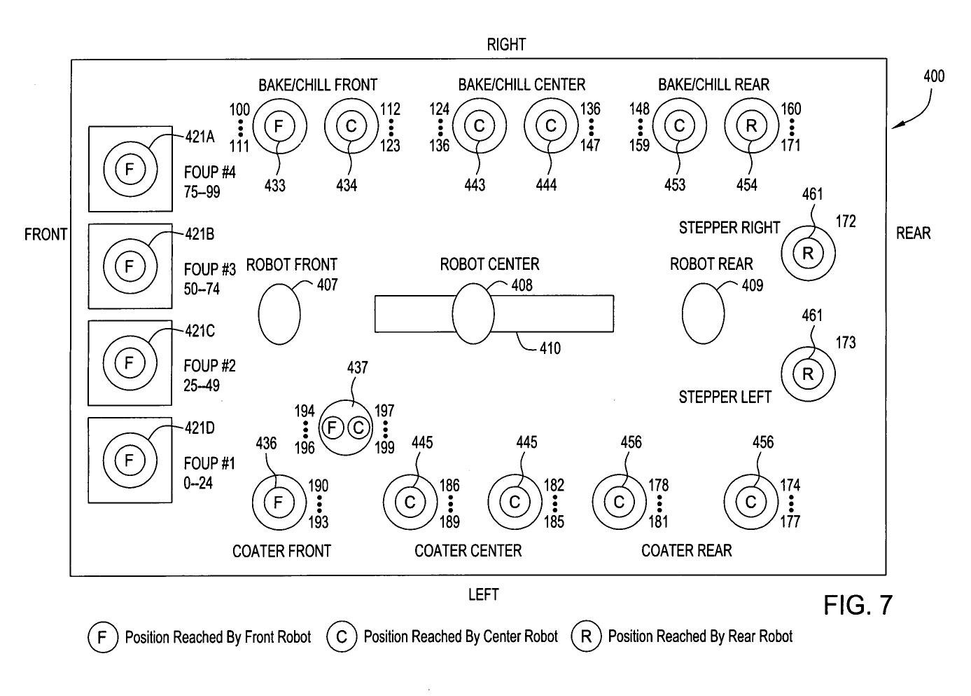

FIG. 7 illustrates an schematic figure of a mockup cell 400 configured to simulate a cluster tool, such as the cluster tool 100 of FIG. 1, and to adapted to find optimized robot trajectories that avoid collision and improve system throughput. The mockup cell 400 generally comprises front-end opening unified pods (FOUPs) 421A-421D adapted to accept one or more substrates therein. A plurality of front bake and chill stations 433 and 434 are generally disposed on a right processing rack. A shuttle station (not shown) may be used to transfer a substrate between a corresponding pair of front bake and chill station 433 and 434. A plurality of front coaters 436 are disposed on a left processing rack. A front robot 407 is disposed inside the mockup cell 400 near the front. A plurality of center bake and chill stations 443 and 444 are generally disposed near the center on the right processing rack. A plurality of center coaters 445 are disposed near the center on the left processing rack. A center robot 408 having a track 410 is disposed inside the mockup cell 400 near the center. A plurality of rear bake and chill stations 453 and 454 are generally disposed near the back on the right processing rack. A plurality of rear coaters 456 are disposed near the back on the left processing rack. A rear robot 409 is disposed inside the mockup cell 400 near the back. A pair of stepper scanners 461 are generally disposed on the rear end of the mockup cell 400.

In one embodiment, each station or chamber where a substrate may be picked up or dropped off by robots 407, 408 and/or 409 is considered a destination position. A numeral is assigned to each destination position for convenience, as shown in FIG. 7. In one embodiment, each destination position is accessible only by one robot so that collisions between robots may be avoided at the destination positions. In one embodiment, a shuttle station may be used to transfer a substrate from a destination position accessible by one robot to a destination position accessible by another robot, such as between the front bake and chill stations 433 and 434. In another embodiment, a de-pair may be used to turn one station or chamber into two destination positions so that two different robots may both have access to the station or chamber at any time without collision.

As shown in FIG. 7, positions accessible by the front robot 407 is marked by “F”; positions accessible only by the center robot 408 is marked by “C”; and positions accessible only by the rear robot 409 is marked by “R”. For each robot, a point tree of intermediate points may be obtained by using a path-finding graph algorithm. Optimization may be used to find the most efficient and safe path between any two destination positions of one robot. In one embodiment, a weighted point tree may be used. In one aspect, the weighted point tree may be obtained to optimize the system throughput wherein weights are assigned in a manner that matches time consumed by the corresponding motion. In another aspect, the weighted point tree may be obtained alone or combined with other parameters, such as for example the amount of wafer deviation. In one embodiment, a motion between two intermediate points may be weighted using at least one of parameters, such as the time consumed to complete the motion, and the amount of substrate deviation from horizontal.

Simulation of the robots' motions may be produced in the mockup cell 400. Envelope of each robot may be found through simulation so that the envelope of one robot does not overlap with envelope of other robots. In one embodiment, a virtual wall of avoidance may be used to find the envelopes, wherein a virtual wall is described between robots and insisted that all parts of the respective robots would always remain on their side of the wall.

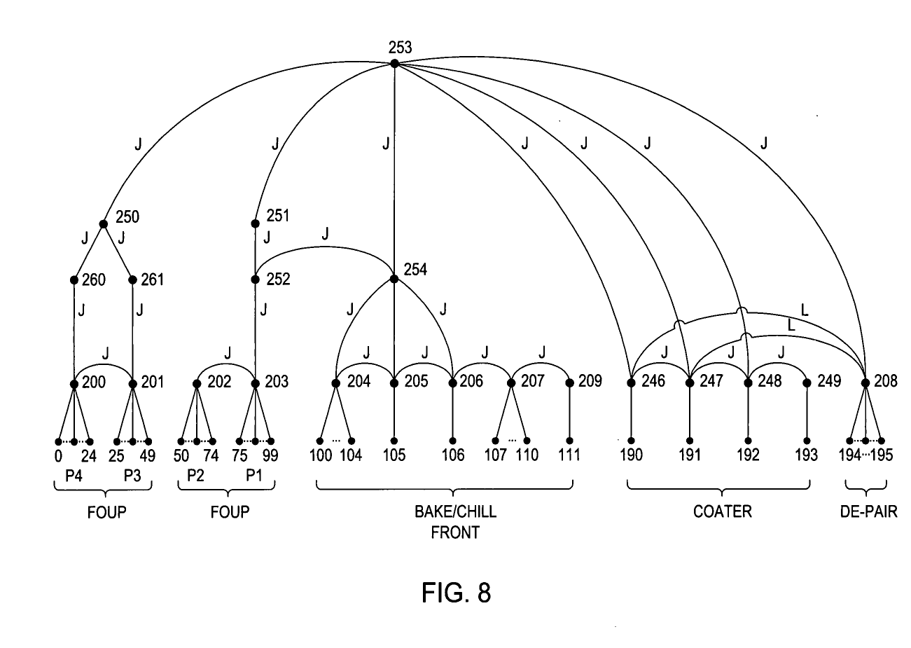

FIGS. 8-10 illustrates exemplary point trees of, the front robot 407, the center robot 408 and the rear robot 409 of the mockup cell 400 of FIG. 7 respectively.

As shown in FIG. 8, the bottom nodes denotes destination positions of the front robot 407. A set of optimized intermediate points and trajectories passing the set of intermediate points are indicated by the tree. The front robot 407 is capable of moving between any two given destination positions with at least one trajectory. During operation, the front robot 407 follows the trajectories shown in FIG. 8 exclusively, therefore, stays away from the envelopes of the center robot 408 and the rear robot 409 and becomes collision free. A line marked with an “L” represents a linear motion between the corresponding two points it connects. A line marked with a “J” represents a joint motion between the corresponding two points it connects.

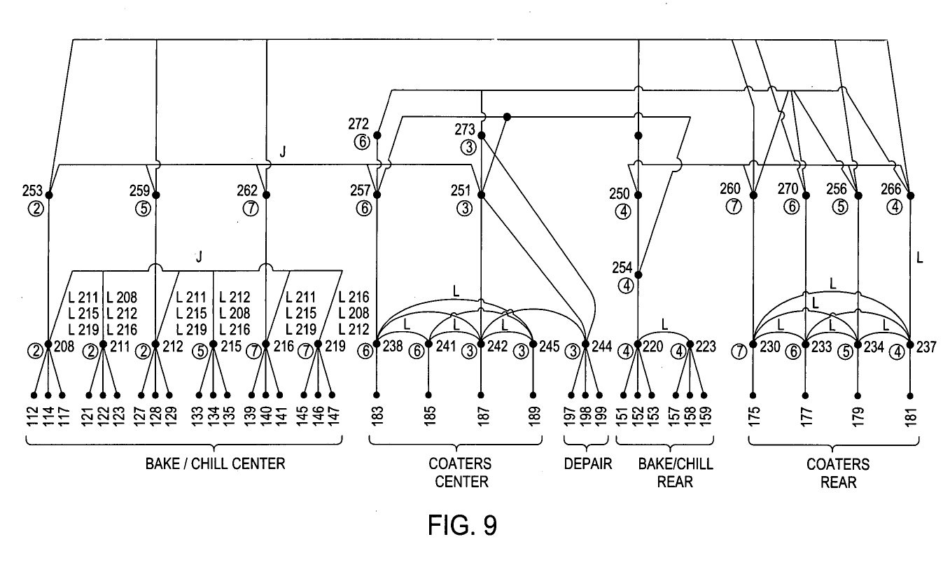

As shown in FIG. 9, the bottom nodes denotes destination positions of the center robot 408. A set of optimized intermediate points and trajectories passing the set of intermediate points are indicated by the tree. The center robot 408 is capable of moving between any two given destination positions with at least one trajectory. During operation, the center robot 408 follows the trajectories shown in FIG. 8 exclusively, therefore, stays away from the envelopes of the front robot 407 and the rear robot 409 and becomes collision free. A line marked with an “L” represents a linear motion between the corresponding two points it connects. A line marked with a “J” represents a joint motion between the corresponding two points it connects. The small numbers in a circle represents the position of a robot's track position, for example, the central robot 108's location on the track 110 in FIG. 1.

In one embodiment, in order to improve system throughput, it is desirable to minimize unnecessary track moves since track moves are slow and to maximize the overlap of robot's axis' move with the track move. The minimizing of track moves may be achieved by using weights to each motion. For example, in FIG. 8, weights for all motions were set initially to 10 except as follows:

208<->253=9

208<->anything else=11

211<->anything else=11

212<->259=9

212<->anything else=11

214<->anything else=11

215<->anything else=11

216<->262=9

216<->219=10

216<->anything else=11

238<->242=11

238<->245=11

241<->242=11

242<->251=11

Then between any two points, if the track position is different, the weight would have 100 added to it. For example, since point 269 and point 270 are at different track positions, the final weight between point 269 and 270 is 110. Since points 241 and 242 are at different track positions, the final weight between points 241 and 242 is 111. While the final weight between the points 242 and 251 is still 11. Therefore, by choosing a path with links having minimal weight values, the robot may maximize throughput.

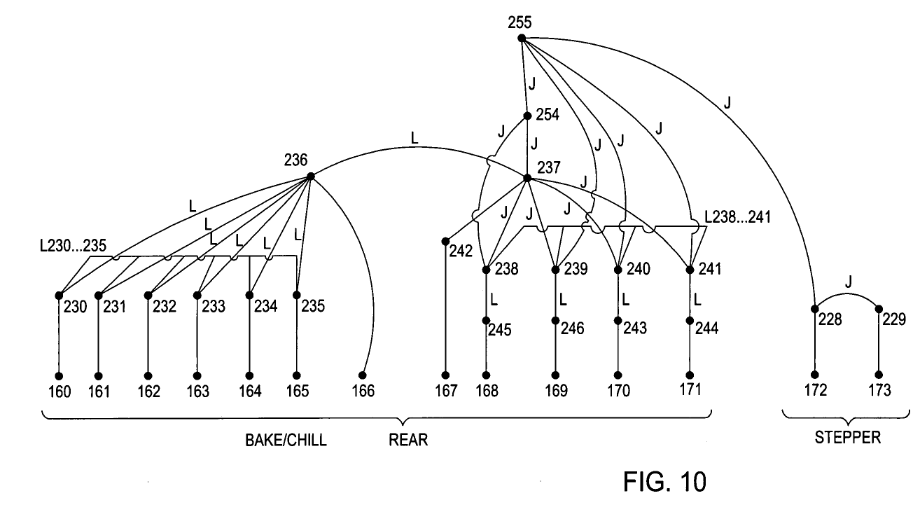

Similarly, FIG. 10 illustrates a set of optimized intermediate and trajectories of the rear robot 409. The rear robot 409 is capable of moving between any two given destination positions with at least one trajectory. During operation, the rear robot 409 follows the trajectories shown in FIG. 10 exclusively, therefore, stays away from the envelopes of the front robot 407 and the center robot 408 and becomes collision free.

It should be noted that although only cluster tools for photolithography process are described in this application, the present invention may be adapted to other processing tool where one or more robots corporate to conduct a sequence of processing steps. A person skilled in the art may adapt the present invention in applicable circumstances.

While the foregoing is directed to embodiments of the present invention, other and further embodiments of the invention may be devised without departing from the basic scope thereof, and the scope thereof is determined by the claims that follow.

1. A method of collision avoidance in a cluster tool having a plurality of processing stations and at least two robots, comprising:
for each of the at least two robots, determining a set of designated processing stations to which the robot has access, wherein each of the plurality of processing stations is accessible by only one of the at least two robots; and
for each of the at least two robots, determining a set of trajectories, wherein each robot is capable of transferring substrates among the corresponding set of designated processing stations by following the corresponding set of trajectories,
wherein the set of trajectories for each robot forms an envelope, and the envelope of each robot does not overlap.

2. The method of claim 1, wherein determining the set of trajectories comprises:
finding at least one intermediate point between two processing stations within the set of designated processing stations; and
building a point tree from the set of designated processing stations and the intermediate points.

3. The method of claim 2, wherein building the point tree comprises adding weights to branches of the point tree.

4. The method of claim 3, wherein the weights are determined by at least one of a time consumed for the robot to follow each branch and an amount of horizontal deviation.

5. The method of claim 1, wherein determining the set of trajectories is performed using simulation.

6. The method of claim 1, wherein determining the set of trajectories comprises adjusting the set of trajectories of one robot according to the set of trajectories of other robots.

7. The method of claim 1, further comprising providing at least one of a shuttle station or a de-pair adapted to transfer substrates between processing stations accessible to different robots.

8. The method of claim 1, further comprising determining base locations of the at least two robots.

9. The method of claim 1, wherein the determining the set of trajectories is performed offline.

10. A cluster tool for processing a substrate, comprising:
a first processing rack containing vertical stacks of substrate processing chambers;
a second processing rack containing vertical stacks of substrate processing chambers;
a first robot disposed between the first and second processing racks, wherein the first robot is adapted to transfer the substrate among the substrate processing chambers by following a first set of predetermined trajectories; and
a second robot disposed between the first and second processing racks, wherein the second robot is adapted to transfer the substrate among the substrate processing chambers by following a second set of predetermined trajectories, wherein the first and second set of predetermined trajectories are determined such that the first and second robots do not collide by following the corresponding set of predetermined trajectories.

11. The cluster tool of claim 10, wherein the first robot is adapted to access a first set of substrate processing chambers, the second robot is adapted to access a second set of substrate processing chambers, and the first and second set of processing chambers do not overlap.

12. The cluster tool of claim 11, further comprising a plurality of shuttle stations, each configured to transfer substrates between one of the first set of processing chambers to one of the second set of processing chambers.

13. The cluster tool of claim 10, further comprising a plurality of de-pairs, each configured to make one processing chamber accessible to the first and second robots from two sides.

14. The cluster tool of claim 10, wherein the first robot is movable along a track.

15. The cluster tool of claim 10 further comprising a third robot disposed between the first and second processing racks, wherein the third robot is adapted to transfer the substrate among the substrate processing chambers by following a third set of predetermined trajectories which ensures the third robot does not collide with the first and second robot.

16. The cluster tool of claim 10, wherein the first and second set of predetermined trajectories are determined offline using a mockup cell.

17. A method for processing a substrate in a cluster tool, comprising:
providing a plurality of processing stations;
providing a first robot configured to transfer substrates among a first set of processing stations of the plurality of processing stations;
providing a second robot configured to transfer substrates among a second set of processing stations of the plurality of processing stations, wherein the first and second set of processing stations do not overlap;
handling the substrate by the first robot following a first set of predetermined trajectories;
transferring the substrate from one of the first set of processing station to one of the second set of processing stations; and
handling the substrate by the second robot following a second set of predetermined trajectories, wherein the first and second set of predetermined trajectories are determined such that the first and second robots do not collide by following the corresponding set of predetermined trajectories.

18. The method of claim 17, wherein the transferring the substrate is performed by a shuttle station.

19. The method of claim 17, wherein the transferring the substrate is performed by using a depair station.

20. The method of claim 17 further comprising finding the first and second set of predetermined trajectories using simulations of a mockup cell.
